(19) United States
(12) Patent Application Publication
(10) Pub. No.: US 2026/0155748 A1
(43) Pub. Date: Jun. 4, 2026

(54) MULTI-PHASE VOLTAGE REGULATOR WITH DYNAMIC VOLTAGE CONTROL

(71) Applicant: Chengdu Monolithic Power Systems Co., Ltd., Chengdu (CN)

(72) Inventors: Shun Liu, Hangzhou (CN); Jianbo Xu, Hangzhou (CN); Jianan Wang, Hangzhou (CN)

(21) Appl. No.: 19/402,219

(22) Filed: Nov. 26, 2025

(30) Foreign Application Priority Data
Nov. 29, 2024 (CN) 202411735506.7

(51) Int. Cl. H02M 3/158; H02M 1/00

(52) U.S. Cl. CPC H02M 3/1584; H02M 1/0009

(57) ABSTRACT

A controller of a multi-phase voltage regulator has a communication pin, a plurality of phase current sensing pins, and a plurality of switching control pins. The communication pin receives a voltage control command. Each of the plurality of phase current sensing pins senses a current flowing through a corresponding one of a plurality of switching circuits. The plurality of switching control pins provide a plurality of switching control signals to control the plurality of switching circuits. The controller determines a number of the switching circuits for power operation based on an output current of the multi-phase voltage regulator. In response to the voltage control command that changes an output voltage of the multi-phase voltage regulator, the controller determines whether to increase the number of the switching circuits for power operation based on the current flowing through one of the plurality of switching circuits.

### CROSS-REFERENCE TO RELATED APPLICATIONS

This application claims the benefit of CN application No. 202411735506.7, filed on Nov. 29, 2024, and incorporated herein by reference.

### BACKGROUND OF THE INVENTION

### 1. Field of the Invention

The present invention generally relates to electronic circuits, and more particularly, relates to multi-phase voltage regulators.

### 2. Description of Related Art

In a computer system, an operating voltage of a processor such as a central processing unit (CPU) or a graphics processing unit (GPU) varies based on their operating modes. Typically, a multi-phase voltage regulator is employed to supply the required operating voltage to the processor. The operating voltage provided by the multi-phase voltage regulator is adjusted based on a voltage identification code sent by the processor.

An existing processor power supply system generates a reference voltage based on the voltage identification code, and the multi-phase voltage regulator converts an input voltage into an output voltage based on the reference voltage. The output voltage of the multi-phase voltage regulator is the operating voltage of the processor. Generally, switches of at least one switching circuit of the multi-phase voltage regulator are controlled to turn on and off based on a feedback signal of the output voltage and the reference voltage.

### SUMMARY OF THE INVENTION

Embodiments of the present invention are directed to a control method for a multi-phase voltage regulator, comprising providing an output voltage and an output current to a load; receiving a voltage control command provided by the load; determining a number of switching circuits for power operation based on the output current; providing a current sensing signal based on a current flowing through one of the switching circuits; determining whether to increase the number of the switching circuits for power operation based on a comparison between the current sensing signal and a first phase adding threshold in response to the voltage control command that increases the output voltage; and determining whether to increase the number of the switching circuits for power operation based on a comparison between the current sensing signal and a second phase adding threshold in response to the voltage control command that decreases the output voltage.

Embodiments of the present invention are directed to a controller of a multi-phase voltage regulator, the controller comprises a communication pin, a plurality of phase current sensing pins, and a plurality of switching control pins. The communication pin is capable of receiving a voltage control command. Each of the plurality of phase current sensing pins is capable of sensing a current flowing through a corresponding one of a plurality of switching circuits. The plurality of switching control pins are capable of providing a plurality of switching control signals to control the plurality of switching circuits. The controller is capable of determining a number of the switching circuits for power operation based on an output current of the multi-phase voltage regulator. In response to the voltage control command that changes an output voltage of the multi-phase voltage regulator, the controller determines whether to increase the number of the switching circuits for power operation based on the current flowing through one of the plurality of switching circuits.

Embodiments of the present invention are directed to a multi-phase voltage regulator comprising an input terminal capable of receiving an input voltage, an output terminal capable of providing an output voltage to a load, a plurality of switching circuits coupled in parallel between the input terminal and the output terminal, and a controller. The plurality of switching circuits are capable of converting the input voltage to the output voltage. The controller comprises a communication pin capable of receiving a voltage control command, a plurality of switching control pins capable of providing a plurality of switching control signals to control the plurality of switching circuits, and a plurality of phase current sensing pins. Each of the plurality of phase current sensing pins is capable of sensing a current flowing through a corresponding one of the plurality of switching circuits. The controller is capable of determining a number of the switching circuits for power operation based on an output current of the multi-phase voltage regulator. In response to the voltage control command that changes the output voltage of the multi-phase voltage regulator, the controller determines whether to increase the number of the switching circuits for power operation based on the current flowing through one of the plurality of switching circuits.

These and other features of the present invention will be readily apparent to persons of ordinary skill in the art upon reading the entirety of this disclosure, which includes the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically shows a multi-phase voltage regulator 1000 in accordance with an embodiment of the present invention.

FIG. 2 schematically shows a controller 1200 in accordance with an embodiment of the present invention.

FIG. 3 schematically shows a circuit diagram of a phase adding control unit 1203 in accordance with an embodiment of the present invention.

FIG. 4 shows a flowchart of an automatic phase shedding method 400 for the multi-phase voltage regulator 1000 in accordance with an embodiment of the present invention.

FIG. 5 illustrates a timing diagram 500 of the multi-phase voltage regulator 1000 of FIG. 1 in accordance with an embodiment of the present invention.

FIG. 6 illustrates a timing diagram 600 of the multi-phase voltage regulator 1000 of FIG. 1 in accordance with an embodiment of the present invention.

FIG. 7 shows a flowchart of a control method 700 for a multi-phase voltage regulator in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

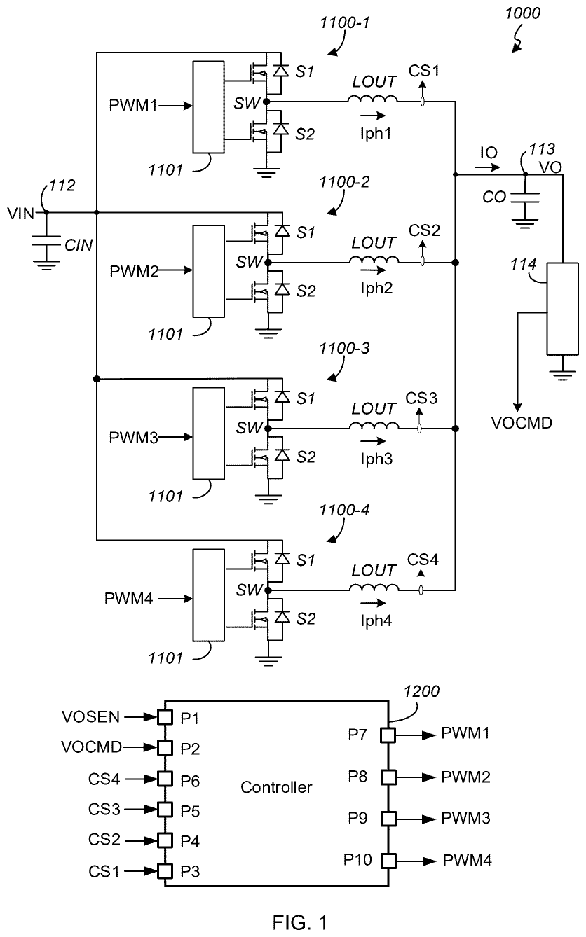

FIG. 1 schematically shows a multi-phase voltage regulator 1000 in accordance with an embodiment of the present invention. The multi-phase voltage regulator 1000 receives an input voltage VIN at its input terminal 112 and provides an output voltage VO and an output current IO to a load 114 at its output terminal 113. In one example, the load 114 comprises a processor.

The multi-phase voltage regulator 1000 comprises a plurality of switching circuits (e.g., 1100-1, 1100-2, 1100-3, and 1100-4 shown in FIG. 1) coupled in parallel between the input terminal 112 and the output terminal 113. In the embodiment of FIG. 1, each switching circuit 1100 has a driver 1101, a pair of power switches S1-S2, and an output inductor LOUT. The plurality of switching circuits convert the input voltage VIN into the output voltage VO under the control of the switching control signals PWM1-PWM4. For example, the switching circuit 1100-1 is turned on and off under the control of the switching control signal PWM1, the switching circuit 1100-2 is turned on and off under the control of the switching control signal PWM2, the switching circuit 1100-3 is turned on and off under the control of the switching control signal PWM3, and the switching circuit 1100-4 is turned on and off under the control of the switching control signal PWM4. The switching circuit 1100-1 is described below as an example. When the switching control signal PWM1 is in a first state (e.g., logic high), the power switch S1 of the switching circuit 1100-1 is turned on, and the power switch S2 is turned off. A switching node SW formed by the power switch S1 and the power switch S2 is electrically connected to the input terminal 112. When the switching control signal PWM1 is in a second state (e.g., logic low), the power switch S1 of the switching circuit 1100-1 is turned off and the power switch S2 is turned on. The switching node SW formed by the power switch S1 and the power switch S2 is electrically connected to the reference ground. One end of the output inductor LOUT is electrically connected to the switching node SW, and another end of the output inductor LOUT is electrically connected to the output terminal 113. When the switching control signal PWM1 is in a third state (e.g., a high-impedance state), the power switches S1 and S2 of the switching circuit 1100-1 remain off, and the switching circuit 1100-1 is not for power operation. In one embodiment, a voltage level between the high threshold voltage (e.g., 2V) and a supply voltage (e.g., 3.3 V) is considered as logic high, a voltage level between zero voltage (0V) and a low threshold voltage (e.g., 1V) is considered as logic low, and a voltage level between the high threshold voltage and the low threshold voltage is considered as a high-impedance state. The embodiment shown in FIG. 1 is described by taking four phases (i.e., four switching circuits) as an example, and one with ordinary skill in the art should understand that the multi-phase voltage regulator 1000 may have more than or less than four switching circuits shown in FIG. 1.

The multi-phase voltage regulator 1000 also has a controller 1200. The controller 1200 determines a number NUM of active phases in a steady state based on the output current IO, wherein the “active phase in the steady state” refers to the switching circuit for power operation in a steady state of the multi-phase voltage regulator 1000. In the embodiments of the present disclosure, the steady state refers to the state that the output voltage VO is maintained within a tight tolerance, exhibiting no significant drift or fluctuations. The controller 1200 further receives a voltage control command VOCMD. In one embodiment, the voltage control command VOCMD is provided by the load 114. The voltage control command VOCMD comprises a dynamic voltage identification code (DVID) command in one example, which changes the output voltage VO of the multi-phase voltage regulator 1000. When the voltage control command VOCMD controls the output voltage VO to change, the controller 1200 determines whether to increase the number of the active phases, based on a current (e.g., Iph1) flowing through one of the switching circuits.

In one embodiment, the voltage control command VOCMD command has, for example, an output voltage increasing command (the output voltage VO increases to a higher voltage value) and an output voltage decreasing command (the output voltage VO decreases to a lower voltage value). During the increase of the output voltage VO, the multi-phase voltage regulator 1000 provides a positive current to charge an output capacitor CO, so that the output voltage VO increases at a first preset slope. During the decrease of the output voltage VO, the multi-phase voltage regulator 1000 provides a negative current to discharge the output capacitor CO, so that the output voltage VO decreases at a second preset slope. In order to respond quickly to the command of changing the output voltage VO, the multi-phase voltage regulator in prior art activates all the switching circuits upon receiving the command of changing the output voltage VO, i.e., all the switching circuits are activated for power operation. However, when all the switching circuits are active, power loss is also large. During dynamic voltage control of the output voltage VO, i.e., from receiving the command of changing the output voltage VO to a time when the output voltage VO reaches an expected voltage value, the embodiments of the present disclosure automatically determine whether to increase the number of the active phases in a manner different from both the steady-state operation and the simultaneous activation of all the phases. Therefore, the multi-phase voltage regulator could quickly respond to the command of changing the output voltage VO and also holds the advantage of small power loss and high efficiency.

In one embodiment, the controller 1200 is integrated in an integrated circuit (IC), and has a voltage sensing pin P1, a communication pin P2, a plurality of phase current sensing pins P3-P6, and a plurality of switching control pins P7-P10. The voltage sensing pin P1 receives a voltage sensing signal VOSEN representing the output voltage VO. The communication pin P2 receives the voltage control command VOCMD. The phase current sensing pin P3 receives a phase current sensing signal CS1 representing the current Iph1 flowing through the switching circuit 1100-1. The phase current sensing pin P4 receives a phase current sensing signal CS2 representing the current Iph2 flowing through the switching circuit 1100-2. The phase current sensing pin P5 receives a phase current sensing signal CS3 representing the current Iph3 flowing through the switching circuit 1100-3. The phase current sensing pin P6 receives a phase current sensing signal CS4 representing the current Iph4 flowing through the switching circuit 1100-4. The switching control pins P7-P10 provide switching control signals PWM1-PWM4.

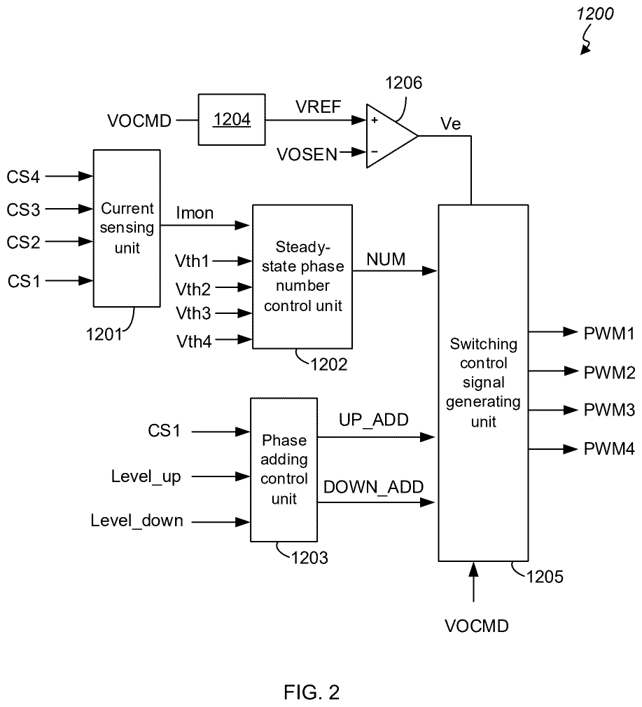

FIG. 2 schematically shows a controller 1200 in accordance with an embodiment of the present invention. In the embodiment of FIG. 2, the controller 1200 has a current sensing unit 1201, a steady-state phase number control unit 1202, and a phase adding control unit 1203.

The current sensing unit 1201 provides a total current sensing signal Imon representing the output current IO based on the phase current sensing signals CS1 to CS4. The current sensing unit 1201 may provide the total current sensing signal Imon based on one of the phase current sensing signals CS1-CS4, or provide the total current sensing signal Imon based on a sum of all the phase current sensing signals CS1-CS4. In another embodiment, the controller 1200 may also directly receive a sensing signal of the output current IO and provide the total current sensing signal Imon based on the sensing signal of the output current IO.

| Conditions | Working Mode |
|---|---|
| Imon > Vth_4ph + VHYS | 4 phases working in CCM |
| Vth_3ph + VHYS < Imon ≤ Vth_4ph | 3 phases working in CCM |
| Vth_2ph + VHYS < Imon ≤ Vth_3ph | 2 phases working in CCM |
| Vth_1ph + VHYS < Imon ≤ Vth_2ph | 1 phase working in CCM |
| Imon ≤ Vth_1ph | 1 phase working in DCM |

The steady-state phase number control unit 1202 determines the number NUM of the active phases in the steady state based on the output current IO. For example, the total current sensing signal Imon is compared with a plurality of phase shedding thresholds Vth1-Vth4 respectively, and the number NUM of the active phases in the steady state is determined based on a comparison between the total current sensing signal Imon and the phase shedding thresholds Vth1-Vth4, as shown in the table above. In the table above, VHYS is a hysteresis voltage, CCM represents a continuous current mode, and DCM represents a discontinuous current mode. When the number NUM of the active phases in the steady state is 1, for example, only the switching circuit 1100-1 is for power operation, and the switching circuits 1100-2, 1100-3, and 1100-4 are not for power operation. When the number NUM of the active phases in the steady state is 2, for example, the switching circuits 1100-1 and 1100-2 are for power operation, and the switching circuits 1100-3 and 1100-4 are not for power operation. When the number NUM of the active phases in the steady state is 3, for example, the switching circuits 1100-1, 1100-2, and 1100-3 are for power operation, and the switching circuit 1100-4 is not for power operation. When the number NUM of the active phases in the steady state is 4, all the switching circuits 1100-1, 1100-2, 1100-3, and 1100-4 are for power operation. In one embodiment, the switching circuit 1100-1 may be regarded as a first phase, the switching circuit 1100-2 may be regarded as a second phase, the switching circuit 1100-3 may be regarded as a third phase, and the switching circuit 1100-4 may be regarded as a fourth phase.

The phase adding control unit 1203 provides the phase adding control signal UP_ADD by comparing the phase current sensing signal CS1 with a phase adding threshold Level_up, and provides the phase adding control signal DOWN_ADD by comparing the phase current sensing signal CS1 with a phase adding threshold Level_down. The phase adding threshold Level_up is the phase adding threshold when the voltage control command VOCMD controls the output voltage VO to increase. The phase adding threshold Level_down is the phase adding threshold when the voltage control command VOCMD controls the output voltage VO to decrease. In one embodiment, the phase adding threshold Level_up is greater than the phase adding threshold Level_down. During the output voltage VO increasing under the control of the voltage control command VOCMD, the controller 1200 determines whether to increase the number of the active phases based on the phase adding control signal UP_ADD. During the output voltage VO decreasing under the control of the voltage control command VOCMD, the controller 1200 determines whether to increase the number of the active phases based on the phase adding control signal DOWN_ADD.

In the embodiment shown in FIG. 2, the controller 1200 further has a reference voltage generation unit 1204. The reference voltage generation unit 1204 provides a reference voltage VREF based on the voltage control command VOCMD, thereby controlling the output voltage VO. A comparison circuit or an error amplifying circuit 1206 provides a loop signal Ve based on the output voltage sensing signal VOSEN and the reference voltage VREF. A switching control signal generating unit 1205 provides the plurality of switching control signals PWM1-PWM4 based on the loop signal Ve, the number NUM of the active phases in the steady state, the phase adding control signal UP_ADD, and the phase adding control signal DOWN_ADD.

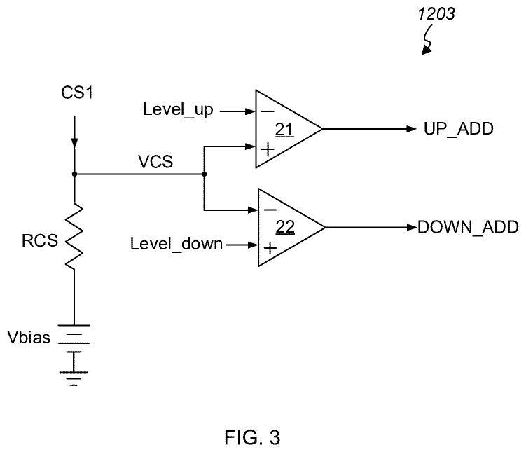

FIG. 3 schematically shows a circuit diagram of a phase adding control unit 1203 in accordance with an embodiment of the present invention. In the example of FIG. 3, the phase current sensing signal CS1 is a current signal flowing through a resistor RCS and a bias voltage source Vbias, generating a current sensing signal VCS at one end of the resistor RCS.

In the embodiment of FIG. 3, the current sensing signal VCS is compared with the phase adding threshold Level_up to generate the phase adding control signal UP_ADD. For example, a comparison circuit 21 is used to compare the current sensing signal VCS with the phase adding threshold Level_up. In response to the current sensing signal VCS being greater than the phase adding threshold Level_up, the phase adding control signal UP_ADD becomes valid, for example, becomes logic high, to indicate that when the voltage control command VOCMD controls the output voltage VO to increase, the number of the active phases needs to be increased. In the embodiment of FIG. 3, the current sensing signal VCS is compared with the phase adding threshold Level_down to generate the phase adding control signal DOWN_ADD. For example, a comparison circuit 21 is used to compare the current sensing signal VCS with the phase adding threshold Level_down. In response to the current sensing signal VCS being less than the phase adding threshold Level_down, the phase adding control signal DOWN_ADD becomes valid, for example, becomes logic high, to indicate that when the voltage control command VOCMD controls the output voltage VO to decrease, the number of the active phases needs to be increased.

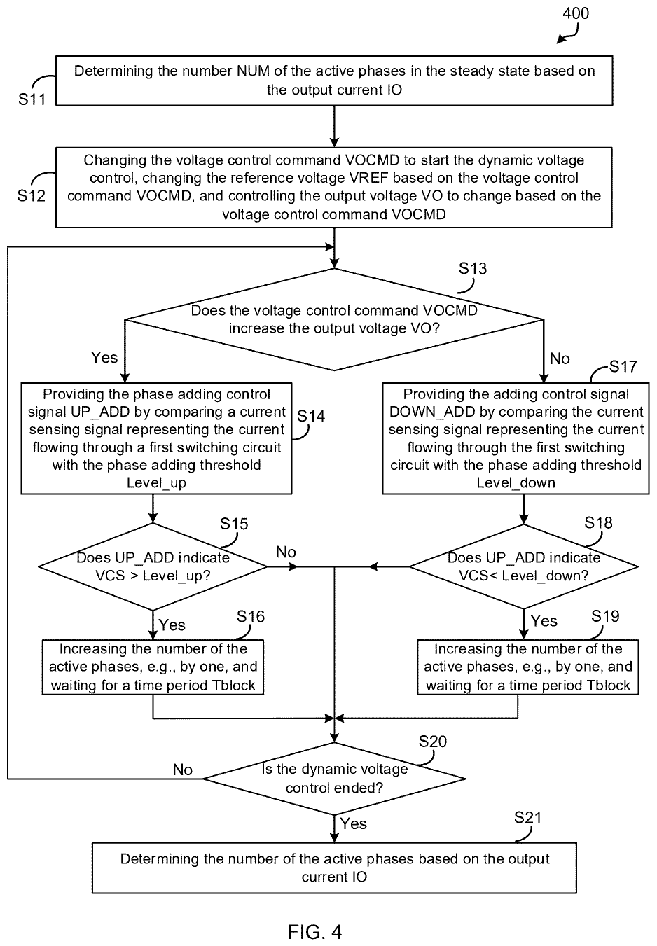

FIG. 4 shows a flowchart of an automatic phase shedding method 400 for the multi-phase voltage regulator 1000 in accordance with an embodiment of the present invention, having steps S11-S21.

In step S11, determining the number NUM of the active phases in the steady state based on the output current IO. In step S12, changing the voltage control command VOCMD to start the dynamic voltage control, changing the reference voltage VREF based on the voltage control command VOCMD, and controlling the output voltage VO to change based on the voltage control command VOCMD. In step S13, determining whether the voltage control command VOCMD is configured to increase the output voltage VO. If the voltage control command VOCMD controls the output voltage VO to increase, then go to steps S14-S20. If the voltage control command VOCMD controls the output voltage VO to decrease, then go to steps S17-S20.

In step S14, providing the phase adding control signal UP_ADD by comparing a current sensing signal (e.g., VCS) with the phase adding threshold Level_up, wherein the current sensing signal represents the current flowing through a first switching circuit. In step S15, in response to the phase adding control signal UP_ADD indicating that the current sensing signal VCS is greater than the phase adding threshold Level_up, step S16 is performed to increase the number of the active phases, e.g., to add one switching circuit for power operation, and step S20 is performed after waiting for a time period Tblock. Otherwise, in response to the phase adding control signal UP_ADD indicating that the current sensing signal VCS is not greater than the phase adding threshold Level_up, step 20 is performed without changing the number of the active phases.

In step S17, providing the adding control signal DOWN_ADD by comparing the current sensing signal (e.g., VCS) with the phase adding threshold Level_down, wherein the current sensing signal represents the current flowing through the first switching circuit. In step S18, in response to the phase adding control signal DOWN_ADD indicating that the current sensing signal VCS is less than the phase adding threshold Level_down, step S19 is performed to increase the number of the active phases, e.g., to add one switching circuit for power operation, and step S20 is performed after waiting for the time period Tblock. Otherwise, in response to the phase adding control signal DOWN_ADD indicating that the current sensing signal VCS is not less than the phase adding threshold Level_down, step 20 is performed without changing the number of the active phases.

In step S20, determining whether the dynamic voltage control is ended. In one embodiment, once the output voltage VO reaches the expected voltage value set by the voltage control command VOCMD, it is determined that the dynamic voltage control is ended. When the dynamic voltage control is ended, go to step S21, wherein the determination of the number of the active phases based on the output current IO is resumed. Otherwise, if the dynamic voltage control is not ended, go to step S13 to continue determining whether to increase the number of the active phases.

Note that in the automatic phase shedding method 400 described above, the functions indicated in the boxes may also occur in a different order than those shown in FIG. 4. For example, two boxes presented one after another can actually be executed essentially at the same time, or sometimes in reverse order, depending on the specific functionality involved. Based on the automatic phase shedding method according to the embodiments of the present disclosure, a quantity of the activated switching circuits (i.e., phases) in the dynamic voltage control is automatically adjusted, therefore the power loss is reduced when the output voltage VO changes at different slopes. During the output voltage VO increasing under the control of the voltage control command VOCMD, once it is detected that the current sensing signal VCS is greater than the phase adding threshold Level_up, more phases are activated for power operation until the current sensing signal VCS is less than the phase adding threshold Level_up, so as to ensure activating a minimum number of the switching circuits necessary for the output voltage VO to increase at the required slope. During the output voltage VO decreasing under the control of the voltage control command VOCMD, once it is detected that the current sensing signal VCS is less than the phase adding threshold Level_down, more phases are activated for power operation until the current sensing signal VCS is greater than the phase adding threshold Level_down, so as to ensure activating the minimum number of switching circuits necessary for the output voltage VO to decrease at the required slope.

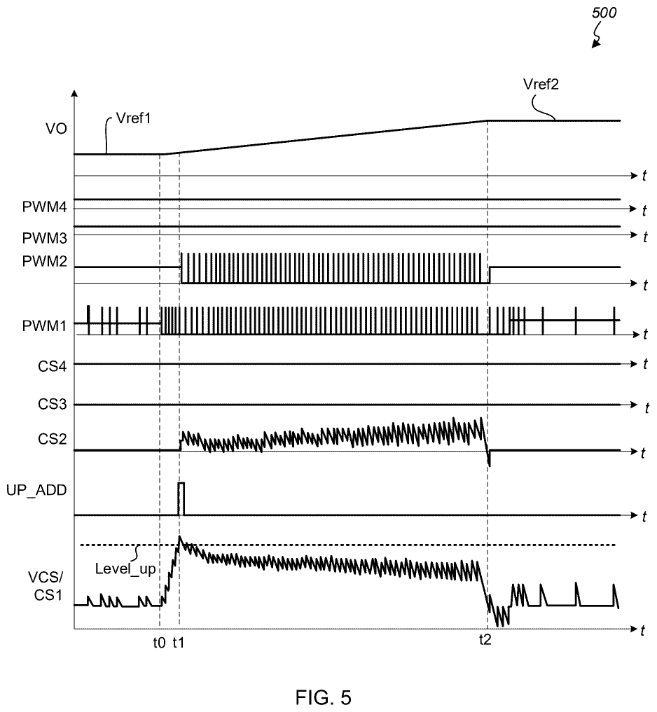

FIG. 5 illustrates a timing diagram 500 of the multi-phase voltage regulator 1000 of FIG. 1 in accordance with an embodiment of the present invention. The timing diagram in FIG. 5 shows, from top to bottom, the output voltage VO, the switching control signals PWM4, PWM3, PWM2 and PWM1, the phase current sensing signals CS4, CS3 and CS2, the phase adding control signal UP_ADD, and the phase current sensing signal CS1 or the current sensing signal VCS. In the example of FIG. 5, the phase current sensing signal CS1 or the current sensing signal VCS represents the current flowing through the first phase (i.e., the first switching circuit) 1100-1.

In the embodiment of FIG. 5, before a time to, the multi-phase voltage regulator 1000 operates in a steady state, and the number of the active phases is determined based on the output current IO. The first switching circuit 1100-1 is for power operation (i.e., being active) under the control of the switching control signal PWM1, and the switching control signals PWM2-PWM4 remain in the high-impedance state to control the other switching circuits 1100-2, 1100-3, and 1100-4 to stay inactive, that is to say, the switching circuits 1100-2, 1100-3, and 1100-4 are not for power operation.

At the time to, the voltage control command VOCMD controls the output voltage VO to increase from a voltage value Vref1, and the dynamic voltage control starts. During increasing the output voltage VO from the voltage value Vref1 to a voltage value Vref2 under the control of the voltage control command VOCMD, the controller 1200 determines whether to increase the number of the active phases based on the phase adding control signal UP_ADD. At a time t1, the phase current sensing signal CS1 or the current sensing signal VCS is greater than the phase adding threshold Level_up, and the phase adding control signal UP_ADD becomes logic high to indicate that more switching circuit is needed for power operation. Therefore, the second switching circuit 1100-2 is added for power operation and is controlled by the switching control signal PWM2. At a time t2, the output voltage VO is equal to the voltage value Vref2, and the controller 1200 resumes determining the number of the active phases based on the output current IO, and as shown in FIG. 5, the switching control signal PWM2 controls the switching circuit 1100-2 to be inactive again.

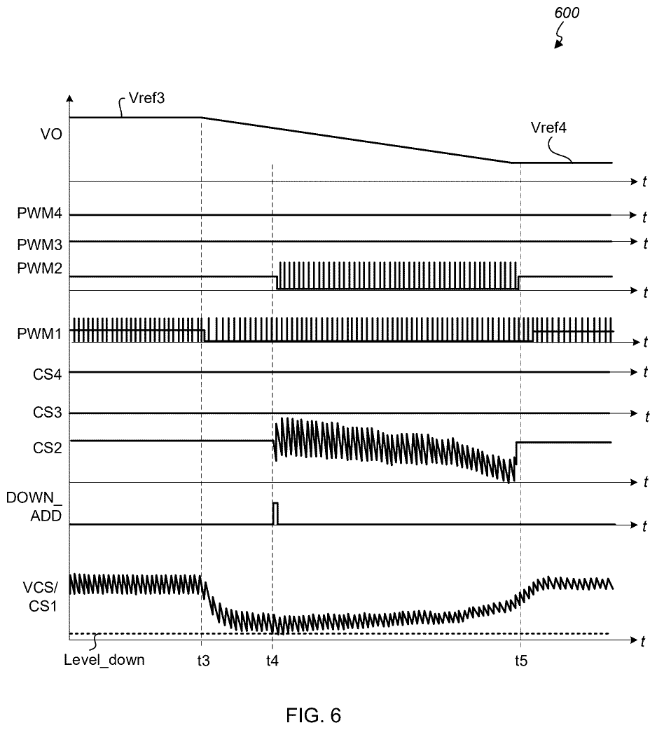

FIG. 6 illustrates a timing diagram 600 of the multi-phase voltage regulator 1000 of FIG. 1 in accordance with an embodiment of the present invention. The timing diagram in FIG. 6 shows, from top to bottom, the output voltage VO, the switching control signals PWM4, PWM3, PWM2 and PWM1, the phase current sensing signals CS4, CS3 and CS2, the phase adding control signal DOWN_ADD, and the phase current sensing signal CS1 or the current sensing signal VCS. In the example of FIG. 6, the phase current sensing signal CS1 or the current sensing signal VCS represents the current flowing through the first switching circuit 1100-1.

In the embodiment shown in FIG. 6, before a time t3, the multi-phase voltage regulator 1000 operates in a steady state, and the number of the active phases is determined based on the output current IO. The first switching circuit 1100-1 is for power operation (i.e., being active) under the control of the switching control signal PWM1, and the switching control signals PWM2-PWM4 remain in the high-impedance state to control the other switching circuits 1100-2, 1100-3, and 1100-4 to stay inactive. At the time t3, the voltage control command VOCMD controls the output voltage VO to decrease from a voltage value Vref3, and the dynamic voltage control starts. During decreasing the output voltage VO from the voltage value Vref3 to a voltage value Vref4 under the control of the voltage control command VOCMD, the controller 1200 determines whether to increase the number of the active phases based on the phase adding control signal DOWN_ADD. At a time t4, the phase current sensing signal CS1 or the current sensing signal VCS is less than the phase adding threshold Level_down, and the phase adding control signal DOWN_ADD becomes logic high to indicate that more switching circuit is needed to enter the power operation. Therefore, the second switching circuit 1100-2 enters the power operation and is controlled by the switching control signal PWM2. At a time t5, the output voltage VO is equal to the voltage value Vref4, and the controller 1200 resumes determining the number of the active phases based on the output current IO, and as shown in FIG. 6, the switching control signal PWM2 controls the switching circuit 1100-2 to be inactive again.

In the embodiments of the present disclosure, in the process of changing the output voltage VO based on the voltage control command VOCMD, when the output voltage VO is changing slowly (i.e., the slope is small), the number of the active phases could be minimized, and when the output voltage VO is changing fast (i.e., the slope is large), more phases could be activated to provide the current required for the change of the output voltage VO. Thus, the multi-phase voltage regulator 1000 achieves fast response to the voltage control command VOCMD for changing the output voltage, and the efficiency of the multi-phase voltage regulator 1000 is also optimized.

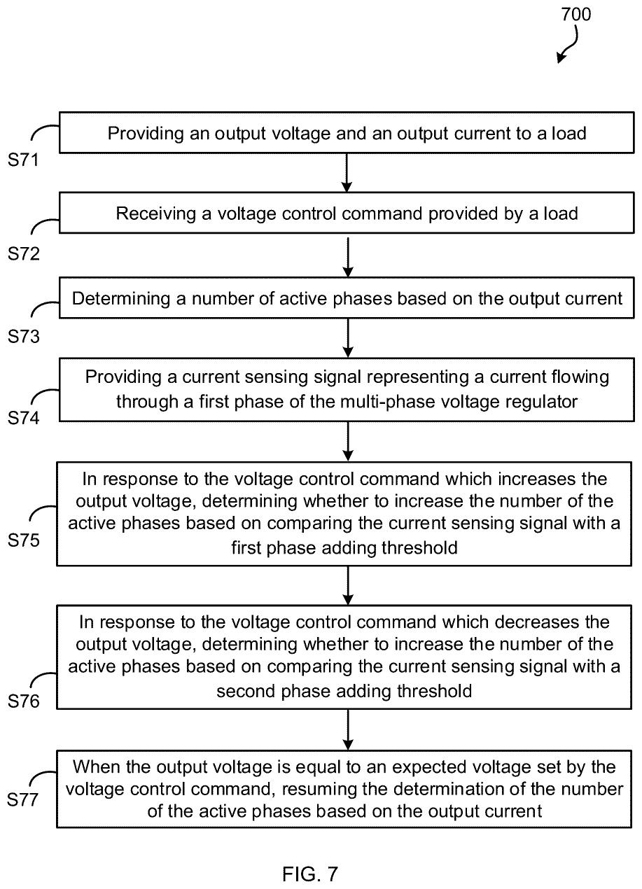

FIG. 7 shows a flowchart of a control method 700 for a multi-phase voltage regulator in accordance with an embodiment of the present invention, having steps S71-S77.

In step S71, providing an output voltage and an output current to a load. In step S72, receiving a voltage control command provided by a load. In step S73, determining a number of active phases (i.e., a number of switching circuits for power operation when the multi-phase voltage regulator 1000 operates) based on the output current. In step S74, providing a current sensing signal, wherein the current sensing signal is configured to represent a current flowing through a first phase of the multi-phase voltage regulator. In step S75, in response to the voltage control command which increases the output voltage, determining whether to increase the number of the active phases based on comparing the current sensing signal with a first phase adding threshold. In step S76, in response to the voltage control command which decreases the output voltage, determining whether to increase the number of the active phases based on comparing the current sensing signal with a second phase adding threshold. In step S77, when the output voltage is equal to an expected voltage set by the voltage control command, resuming the determination of the number of the active phases based on the output current.

In one embodiment, during the output voltage increasing under the control of the voltage control command, once the current sensing signal is greater than the first phase adding threshold, the number of the active phases is increased, e.g., one more phase is activated for power operation. After the number of the active phases is increased, it is determined whether the current sensing signal is still greater than the first phase adding threshold after waiting for a time period. If the current sensing signal is still greater than the first phase adding threshold, then continuing to increase the number of the active phases, e.g., one more phase is activated for power operation. This is repeated until the current sensing signal is less than the first phase adding threshold or all phases have been activated for power operation.

In one embodiment, during the output voltage decreasing under the control of the voltage control command, once the current sensing signal is less than the second phase adding threshold, the number of the active phases is increased, e.g., one more phase is activated for power operation. After the number of the active phases is increased, it is determined whether the current sensing signal is still greater than the second phase adding threshold after waiting for the time period. If the current sensing signal is still greater than the second phase adding threshold, then continuing to increase the number of the active phases, e.g., one more phase is activated for power operation. This is repeated until the current sensing signal is greater than the second phase adding threshold or all phases have been activated for power operation.

Note that in the control method 700 described above, the functions indicated in the boxes may also occur in a different order than those shown in FIG. 7. For example, two boxes presented one after another can actually be executed essentially at the same time, or sometimes in reverse order, depending on the specific functionality involved.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control method for a multi-phase voltage regulator, comprising:
providing an output voltage and an output current to a load;
receiving a voltage control command provided by the load;
determining a number of switching circuits for power operation based on the output current;
providing a current sensing signal based on a current flowing through one of the switching circuits;
in response to the voltage control command that increases the output voltage, determining whether to increase the number of the switching circuits for power operation based on a comparison between the current sensing signal and a first phase adding threshold; and
in response to the voltage control command that decreases the output voltage, determining whether to increase the number of the switching circuits for power operation based on a comparison between the current sensing signal and a second phase adding threshold.

2. The control method of claim 1, wherein during the output voltage increasing under the control of the voltage control command, once the current sensing signal is greater than the first phase adding threshold, increasing the number of the switching circuits for power operation.

3. The control method of claim 2, wherein after increasing the number of the switching circuits for power operation, waiting for a time period, and if the current sensing signal is still greater than the first phase adding threshold, continuing to increase the number of the switching circuits for power operation.

4. The control method of claim 1, wherein during the output voltage decreasing under the control of the voltage control command, once the current sensing signal is less than the second phase adding threshold, increasing the number of the switching circuits for power operation.

5. The control method of claim 4, wherein after increasing the number of the switching circuits for power operation, waiting for a time period, if the current sensing signal is still less than the second phase adding threshold, continuing to increase the number of the switching circuits for power operation.

6. The control method of claim 1, wherein after the output voltage increases or decreases to an expected voltage value set by the voltage control command, resuming the determination of the number of the switching circuits for power operation based on the output current.

7. A controller of a multi-phase voltage regulator, the controller comprising:
a communication pin capable of receiving a voltage control command;
a plurality of phase current sensing pins, wherein each of the plurality of phase current sensing pins is capable of sensing a current flowing through a corresponding one of a plurality of switching circuits; and
a plurality of switching control pins capable of providing a plurality of switching control signals to control the plurality of switching circuits; wherein
the controller is capable of determining a number of the switching circuits for power operation based on an output current of the multi-phase voltage regulator; and wherein
in response to the voltage control command that changes an output voltage of the multi-phase voltage regulator, the controller determines whether to increase the number of the switching circuits for power operation based on the current flowing through one of the plurality of switching circuits.

8. The controller of claim 7, further comprising:
a phase adding control unit, capable of providing a first phase adding control signal by comparing a first current sensing signal with a first phase adding threshold, and providing a second phase adding control signal by comparing the first current sensing signal with a second phase adding threshold, wherein the first current sensing signal is configured to represent the current flowing through the one of the plurality of switching circuits; and
a steady-state phase number control unit, capable of determining the number of the switching circuits for power operation in a steady state of the multi-phase voltage regulator by respectively comparing a second current sensing signal with a plurality of phase shedding thresholds, wherein the second current sensing signal is configured to represent the output current.

9. The controller of claim 8, wherein:
during the output voltage increasing from a first voltage value to a second voltage value under the control of the voltage control command, the controller determines whether to increase the number of the switching circuits for power operation based on the first phase adding control signal; and wherein
after the output voltage is equal to the second voltage value, the number of the switching circuits in the power operation is determined based on the output current.

10. The controller of claim 8, wherein:
during the output voltage decreasing from a third voltage value to a fourth voltage value under the control of the voltage control command, the controller determines whether to increase the number of the switching circuits for power operation based on the second phase adding control signal; and wherein
after the output voltage is equal to the fourth voltage value, the number of the switching circuits in the power operation is determined based on the output current.

11. The controller of claim 7, wherein:
in response to the voltage control command that increases the output voltage, the controller is configured to determine whether to increase the number of the switching circuits in the power operation based on a comparison between a first current sensing signal and a first phase adding threshold, wherein the first current sensing signal is configured to represent the current flowing through the one of the plurality of switching circuits.

12. The controller of claim 7, wherein:
in response to the voltage control command that increases the output voltage, the controller is configured to determine whether to increase the number of the switching circuits in the power operation based on a comparison between a first current sensing signal and a second phase adding threshold, wherein the first current sensing signal is configured to represent the current flowing through the one of the plurality of switching circuits.

13. The controller of claim 7, wherein:
during the output voltage increasing under the control of the voltage control command, once a first current sensing signal is greater than a first phase adding threshold, the number of the switching circuits for power operation is increased, wherein the first current sensing signal is configured to represent the current flowing through the one of the plurality of switching circuits; and wherein
after the number of the switching circuits for power operation is increased, the number of the switching circuits for power operation is further increased in response to the current sensing signal still being greater than the first phase adding threshold.

14. The controller of claim 7, wherein:
during the output voltage decreasing under the control of the voltage control command, once a first current sensing signal is less than a second phase adding threshold, the number of the switching circuits for power operation is increased, wherein the first current sensing signal is configured to represent the current flowing through the one of the plurality of switching circuits; and wherein
after the number of the switching circuits for power operation is increased, the number of the switching circuits for power operation is further increased in response to the current sensing signal still being less than the second phase adding threshold.

15. A multi-phase voltage regulator comprising:
an input terminal capable of receiving an input voltage;
an output terminal capable of providing an output voltage to a load;
a plurality of switching circuits coupled in parallel between the input terminal and the output terminal, wherein the plurality of switching circuits are capable of converting the input voltage to the output voltage; and
a controller comprising a communication pin capable of receiving a voltage control command, a plurality of switching control pins capable of providing a plurality of switching control signals to control the plurality of switching circuits, and a plurality of phase current sensing pins, wherein each of the plurality of phase current sensing pins is capable of sensing a current flowing through a corresponding one of the plurality of switching circuits; wherein
the controller is capable of determining a number of the switching circuits for power operation based on an output current of the multi-phase voltage regulator; and wherein
in response to the voltage control command that changes the output voltage of the multi-phase voltage regulator, the controller determines whether to increase the number of the switching circuits for power operation based on the current flowing through one of the plurality of switching circuits.

16. The multi-phase voltage regulator of claim 7, wherein:
in response to the voltage control command that increases the output voltage, the controller is configured to determine whether to increase the number of the switching circuits in the power operation based on a comparison between a first current sensing signal and a first phase adding threshold, wherein the first current sensing signal is configured to represent the current flowing through the one of the plurality of switching circuits.

17. The multi-phase voltage regulator of claim 7, wherein:
in response to the voltage control command that decreases the output voltage, the controller is configured to determine whether to increase the number of the switching circuits in the power operation based on a comparison between a first current sensing signal and a second phase adding threshold, wherein the first current sensing signal is configured to represent the current flowing through the one of the plurality of switching circuits.

18. The multi-phase voltage regulator of claim 7, wherein:
during the output voltage increasing under the control of the voltage control command, once a first current sensing signal is greater than a first phase adding threshold, the number of the switching circuits for power operation is increased, wherein the first current sensing signal is configured to represent the current flowing through the one of the plurality of switching circuits; and wherein
after the number of the switching circuits for power operation is increased, the number of the switching circuits for power operation is further increased in response to the current sensing signal still being greater than the first phase adding threshold.

19. The multi-phase voltage regulator of claim 7, wherein:
during the output voltage decreasing under the control of the voltage control command, once a first current sensing signal is less than a second phase adding threshold, the number of the switching circuits for power operation is increased, wherein the first current sensing signal is configured to represent the current flowing through the one of the plurality of switching circuits; and wherein
after the number of the switching circuits for power operation is increased, the number of the switching circuits for power operation is further increased in response to the current sensing signal still being less than the second phase adding threshold.
